(19) United States
(12) Patent Application Publication
(10) Pub. No.: US 2026/0147654 A1
(43) Pub. Date: May 28, 2026

(54) EFFICIENT FAULT-TOLERANT MONITORING OF HIGH-DIMENSIONAL SENSOR FEATURES VIA NON-EUCLIDEAN CLUSTERING

(71) Applicant: Dell Products L.P., Round Rock, TX (US)

(72) Inventors: Paulo Abelha Ferreira, Rio de Janeiro (BR); Pablo Nascimento da Silva, Niterói (BR); Vinicius Michel Gottin, Rio de Janeiro (BR)

(21) Appl. No.: 18/957,352

(22) Filed: Nov. 22, 2024

(51) Int. Cl. G06F 11/07

(52) U.S. Cl. CPC G06F 11/0754; G06F 11/0736

(57) ABSTRACT

Determining a fault tolerance level for sensor dimensions by receiving data from each edge node in a group, for each sensor feature across all edge nodes, using the data to calculate covariance matrices at each time window, each sensor feature becoming a path in geometric Riemannian space, forming a first-order multidimensional Riemannian time-series, each dimension corresponding to a correlation dimensions between two edge nodes, creating, from a first-order multidimensional Riemannian time-series, a second-order covariance geometric Riemannian space, using a non-Euclidean PCA at a second-order covariance geometric Riemannian space to determine most relevant dimensions of the group, communicating respective indices of the most relevant dimensions to the edge nodes, receiving, from each of the edge nodes, covariances between the most relevant dimensions, generating a normative cluster of behavior from all of the edge nodes, performing a fault-tolerance analysis based on the normative cluster, and determining a threshold of acceptable fault-tolerance level.

### COPYRIGHT AND MASK WORK NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to monitoring of data generated and/or collected by devices such as sensors. More particularly, at least some embodiments relate to systems, hardware, software, computer-readable media, and methods, for processing disparate datasets from a variety of sensors, and for dealing with missing data and/or faulty collection of data.

### BACKGROUND

The collection, analysis and monitoring of machine sensor data may play an important role in the relationship between a company and its customers, adding value to products through better sizing, configuration, efficiency, and predictive maintenance. Sensors produce data, especially at the lower levels, that comes in the form of multi-dimensional time-series. One goal of monitoring sensor data for analytics is to determine normative from abnormal behavior.

It is possible to directly aggregate all the different sensor features and communicate all of them centrally for data analysis. However, directly aggregating different sensor features is difficult since each one might pertain to a different respective range, and/or behave at a different scale. Further, it can be difficult to deal with missing data and possibly faulty collection of some sensor features.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects a pair of different sensor features collected from an Edge device's sensor system as a two-dimensional time-series—as shown, each feature behaves in different ranges and scales (left and right Y axis).

FIG. 2 discloses an overview of a cyclic framework, and associated method and architecture, according to one embodiment, for determining an adequate fault-tolerance level for different sensor features.

FIG. 3 discloses covariance aggregation for a single feature and a given window time index, according to one embodiment.

FIG. 4 discloses the calculation of covariance matrices for each feature and for all systems' sensor data.

FIG. 5 discloses a path through time in Riemannian space for a given feature, according to one embodiment.

FIG. 6 discloses a first-order time-series for all features and systems in Riemannian space, according to one embodiment.

FIG. 7 discloses generation of a first-order Riemannian multidimensional time series for all features, according to one embodiment.

FIG. 8 discloses a covariance calculation from the first-order time series construction, according to one embodiment.

FIG. 9 discloses a second-order time series and its corresponding set of points, according to one embodiment.

FIG. 10 discloses an approach for dimension dropping for F1-Score calculation, according to one embodiment.

FIG. 11 discloses a fault-tolerance level determination, according to one embodiment.

FIG. 12 discloses an example computing entity configured and operable to perform any of the disclosed methods, processes, and operations.

### DETAILED DESCRIPTION OF SOME EXAMPLE EMBODIMENTS

Embodiments disclosed herein generally relate to monitoring of data generated and/or collected by devices such as sensors. More particularly, at least some embodiments relate to systems, hardware, software, computer-readable media, and methods, for processing disparate datasets from a variety of sensors, and for dealing with missing data and/or faulty collection of data.

One or more example embodiments comprise methods and architectures for processing data collected by one or more edge devices that operate to generate and/or collect data, such as sensors and IoT (internet of things) devices, as well as autonomous vehicles, in an environment where the edge devices are deployed. In some embodiments, the sensors may collect information about the environment, conditions in the environment, and/or the operation of the edge devices themselves. These devices may comprise elements of an edge environment and may be configured to communicate with a central node and/or with one or more near edge nodes. However, the scope of this disclosure is not limited to any particular architecture or environment.

One such method according to an embodiment may be performed recursively and may comprise a training phase, a normative phase, and an inference phase, and each of these phases may comprise a different respective method performed by one or more devices in an edge environment.

One embodiment of a training phase may comprise operations including: 1) collecting time-series from all sensor features and all sources; 2) calculating covariance matrix at the source (or near edge); 3) communicating those covariance matrices to a central node for analysis; 4) at the central node, determining most relevant dimensions through non-Euclidean PCA at the covariance geometric space; and 5) communicating the indices of those relevant dimensions back to the edge nodes.

One embodiment of a normative phase, which may be performed after a training phase has been completed, may comprise operations including: 1) using the indices of relevant dimensions (sensor features), considering only the covariance between them; 2) collecting those covariances and communicating them to the central node; 3) at the central node, calculating feature relevance and producing a normative cluster of behavior from all sources (Riemannian clustering); 4) after the clustering is built, performing a fault-tolerance analysis by dropping some of the dimensions and observing how much that affects an “F1-score” of the new clustering in relation to the old one—that is, how many points have moved from normative <-> Abnormal and vice versa; and, 5) constructing a curve for which a threshold of acceptable fault-tolerance level can be determined.

Finally, an embodiment of an inferencing phrase, which may be performed after completing of a training phase and a normative phase, may comprise operations including: (1) communicating, by the central node, a fault-tolerance level to edge nodes; (2) by the edge nodes, computing with only relevant sensor features; (3) by the edge nodes, monitoring a level of faulty sensor features to see if they are in threshold for communication; and, (4) by an edge node that may be failing less than allowed, subsampling its own sensor features to reduce a communication burden with the central node.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is an approach is provided for efficiently dealing with sensor features at different ranges and scales in a unifying framework for time-series analysis. An embodiment may provide a robust framework for dealing with missing data or faulty collection by automatic calculation of feature relevance and fault-tolerance level. Various other advantages of one or more example embodiments will be apparent from this disclosure.

### A. REFERENCES

Reference may be made herein to the following documents. These are each incorporated herein in their respective entireties by this reference.
[1] Barthélemy, Quentin, et al. “The Riemannian potato field: a tool for online signal quality index of EEG.” IEEE Transactions on Neural Systems and Rehabilitation Engineering 27.2 (2019): 244-255.
[2] Huckemann, Stephan, and Herbert Ziezold. “Principal component analysis for Riemannian manifolds, with an application to triangular shape spaces.” Advances in Applied Probability 38.2 (2006): 299-319.

### B. ASPECTS OF AN EXAMPLE CONTEXT FOR ONE OR MORE EMBODIMENTS

The following is a discussion of aspects of an example context for various embodiments. This discussion is not intended to limit the scope of the claims or this disclosure, or the applicability of the embodiments, in any way.

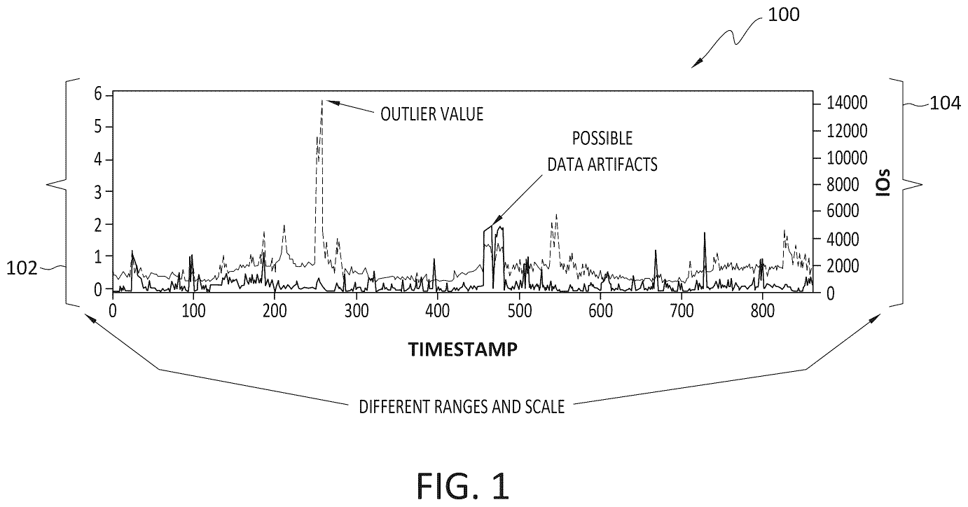

With attention to the example of FIG. 1, there is disclosed a graph 100 that illustrates a pair of different sensor features collected from an edge device sensor system as a two-dimensional time-series. As shown, each feature behaves in different respective ranges and scales 102 and 104 (left and right Y axes). This is only an example of two features, presented for illustrative purposes, but a real world application might be dealing with tens or hundreds, or more, of different features when performing analytics. One way to deal with this is to perform normalization on the features to a normal range, such as 0-1. While this solves the problem of feeding the data to a statistical model, this might be strongly, and undesirably, influenced by outliers and data artifacts.

It might be possible to directly aggregate all the different sensor features and communicate all of them centrally for data analysis. However, directly aggregating different sensor features is difficult since each one might pertain to a different range or behave at a different scale. As such, one embodiment comprises a method to transform the time-series into the covariance between the sensor features. This leads to having to perform quadratic computation, namely, covariance between all sensor features or some subset of sensor features, which is handled by a method according to one embodiment. Additionally, an embodiment may deal with missing data and possibly faulty collection of some sensor features that might occur. To this end, an embodiment may calculate its confidence on the fault-tolerance level.

Thus, one or more embodiments comprise approaches for fault-tolerance monitoring of sensor data, focusing on the two-fold challenge of (1) dealing with a multitude of sensor features at different ranges and scale, with possible outliers and data artifacts, and (2) dealing with faulty data collection, including missing data.

### C. OVERVIEW OF ASPECTS OF AN EXAMPLE EMBODIMENT

One or more embodiments comprise a method and system to calculate a confidence on the fault-tolerance level. One embodiment is concerned with the task of fault-tolerance monitoring from sensor data, focusing on the two challenges noted immediately above. Thus, one embodiment comprises a three-stage cyclic approach as follows:

Training phase: 1) Collect time-series from all sensor features and all sources; 2) Calculate covariance matrix at the source (or near edge); 3) Communicate those covariance matrices to a central node for analysis; 4) At the central node, determine most relevant dimensions through non-Euclidean PCA at the covariance geometric space; and 5) Communicate the indices of those relevant dimensions back to the edge nodes.

Normative phase: 1) using the indices of relevant dimensions (sensor features), consider only the covariance between them; 2) collect those covariances and communicate them to the central node; 3) at the central node, calculate feature relevance and produce a normative cluster of behavior from all sources (Riemannian clustering); 4) once the clustering is built, perform a fault-tolerance analysis by dropping some of the dimensions and seeing how much that affects an “F1-score” of the new clustering in relation to the old one—that is, how many points have moved from normative <-> abnormal, and vice versa; and 5) this will construct a curve for which a threshold of acceptable fault-tolerance level may be determined.

Inference phase: 1) central node communicates fault-tolerance level and feature relevance to edge nodes; 2) edge nodes now compute only with relevant sensor features; 3) edge nodes also monitor level of faulty sensor features to see if they are in threshold for communication; and 4) if edge node is failing less than allowed, it could even subsample its own sensor features to communicate less.

Thus, an embodiment may comprise various useful features and functionalities, although no embodiment is required to possess any of such features and functionalities. The following examples are illustrative, but not exhaustive. An embodiment may comprise a method and/or architecture for efficiently dealing with sensor features at different ranges and scales in a unifying framework for time-series analysis. An embodiment may comprise a robust framework for dealing with missing data or faulty collection by automatic calculation of feature relevance and fault-tolerance level.

### D. DETAILED DISCUSSION

### D.1 Overview

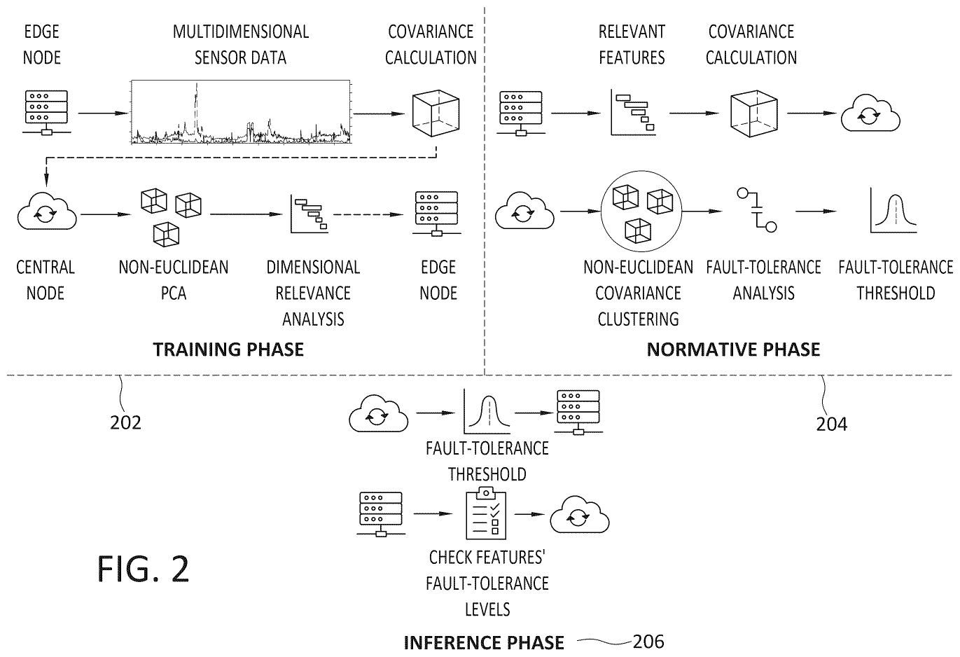

One example embodiment comprises a cyclic framework to determine an adequate fault-tolerance level automatically and periodically for a set of features of sensor data coming from different systems. FIG. 2 discloses an overview of an embodiment of a cyclic framework 200 configured and operable to determine an adequate fault-tolerance level for different sensor features. One embodiment leverages an insight from data analysis in neuroscience, which is to treat the multidimensional time-series data not directly or through normalization, but as covariance between the features. An embodiment then employs an advanced clustering technique tailored for multi-dimensional covariances to perform dimensionality analysis and decide on relevant features. The relevant features are then used to perform an analysis of a robust fault-tolerance level. This cycle can then be repeated, for example, whenever there are more systems entering the analysis, or when it is desirable to do so due to workload change from one or more customers.

As shown in the example of FIG. 2, an embodiment may comprise three stages, namely, a training stage 202, a normative stage 204, and an inference stage 206. The training stage 202 may comprise a dimensionality analysis phase. In an embodiment, a dimensionality analysis phase may comprise operations including: (1) collecting time-series from all sensor features and all sources; (2) calculating a covariance matrix at the source (or near edge); (3) communicating those covariance matrices to a central node for analysis; (4) at the central node or near-edge node, determining the most relevant dimensions through non-Euclidean PCA (principal component analysis) at a second-order covariance geometric Riemannian space; and (5) communicating the indices of those relevant dimensions back to the edge nodes.

A normative phase may comprise operations including: (1) using the indices of relevant dimensions, such as sensor features in one embodiment, considering only the covariance between them; (2) collecting those covariances and communicating them to the central node; (3) at the central node, collecting enough data to produce a normative cluster of behavior from all sources (Riemannian clustering); (4) once the clustering is built, performing a fault-tolerance analysis by dropping some of the dimensions and seeing how much that affects an “F1-score” of the new clustering in relation to the old one, that is, how many points have moved from normative <-> abnormal and vice versa; (5) this will enable construction of a curve for which a threshold of acceptable fault-tolerance level can be determined.

Finally, an inference phase according to one example embodiment may comprise operations including: (1) communicating, by a central node, fault-tolerance level(s) to edge nodes; (2) computing, by the edge nodes, only with relevant sensor features; (3) monitoring, by the edge nodes, the level of faulty sensor features to determine if they are in threshold for communication; and (4) if edge node is failing less than allowed, subsampling, by the edge node, its own sensor features to communicate less. Periodically, an embodiment may cycle back through the training phase, the normative phase, and a new inference phase.

### D.2 Dimensionality Analysis

### D.2.1 Overview

In one embodiment, an aim of a dimensionality analysis phase is to discover the most relevant sensor features, that is ‘dimensions,’ so that nodes can efficiently be clustered into normative, and abnormal, behavior. By identifying, as part of a dimensionality analysis, a small set of relevant features, or dimensions, an embodiment may run analysis on the time-series much more efficiently than if the dimensionality analysis were run on all of the features, or dimensions.

To perform a dimensionality analysis, one embodiment may consider multiple systems, where each system is running, or generating, a multi-feature time-series. In an embodiment, a dimensionality analysis may comprise two stages: (1) aggregating all features from the systems' sensor data into a first-order time-series; and (2) using this aggregated first-order time-series to generate a second-order single-dimension time series on which to run dimensionality importance analysis, such as PCA for example.

In one embodiment, there are various tasks that may be accomplished in this phase. These tasks include (1) gathering and aggregating sensor data from multiple systems, (2) calculating aggregate covariance between sensor features, and (3) identifying the most relevant features.

### D.2.2 First-Order Riemannian Time-Series

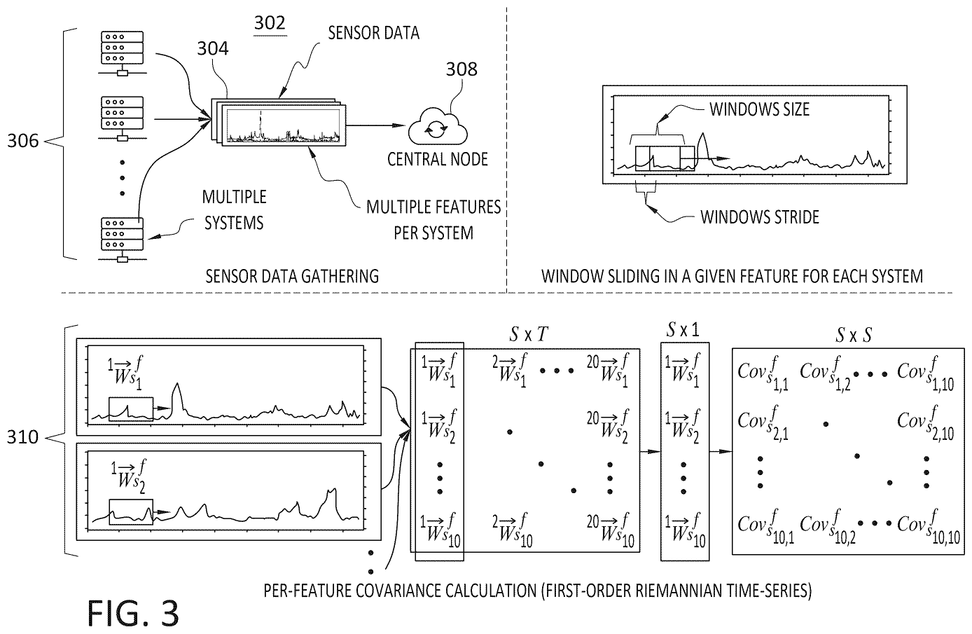

A method according to one embodiment may begin by collecting sensor data, or other edge device/system data, from a set of systems for a pre-established period of time. This data may then be processed at a central node to calculate per-feature covariances across all systems. The example of FIG. 3 shows the process 302 of collecting sensor data 304 from S different systems 306 and centrally, that is, at a central node 308 for example, calculating 310 covariance matrices, one per feature per time window index. If the centrally implemented calculation 310 is repeated for each feature fᵢ∈F and each time index tᵢ∈T, the result is F·T covariance matrices. Each of these matrices is a S×S covariance matrix, expressing the covariance between each system against another system, (1) for a given feature and (2) at a given window time index. In the examples below, for explanation clarity, it is assumed that there are 10 systems, that is, S=10.

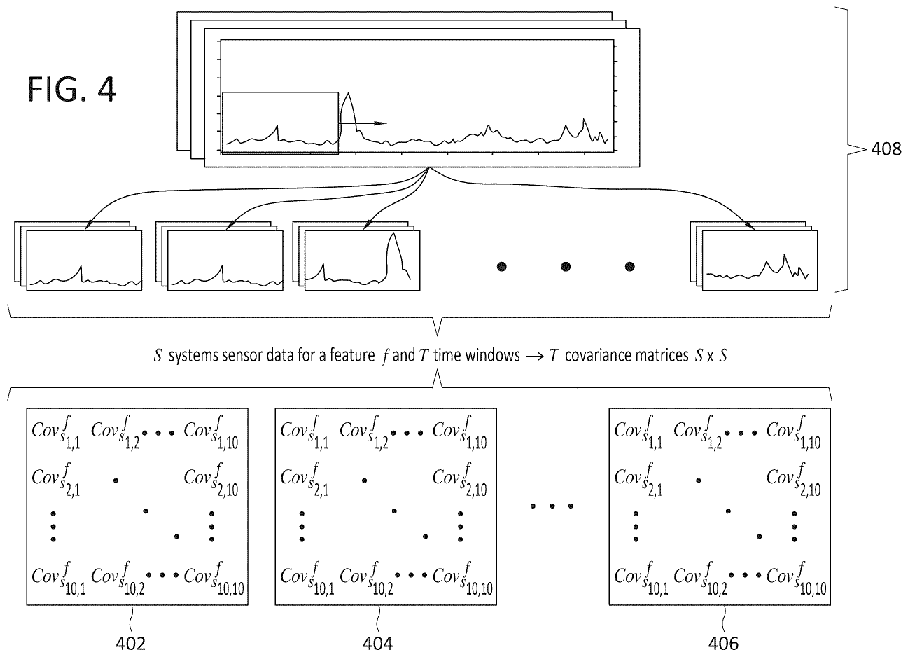

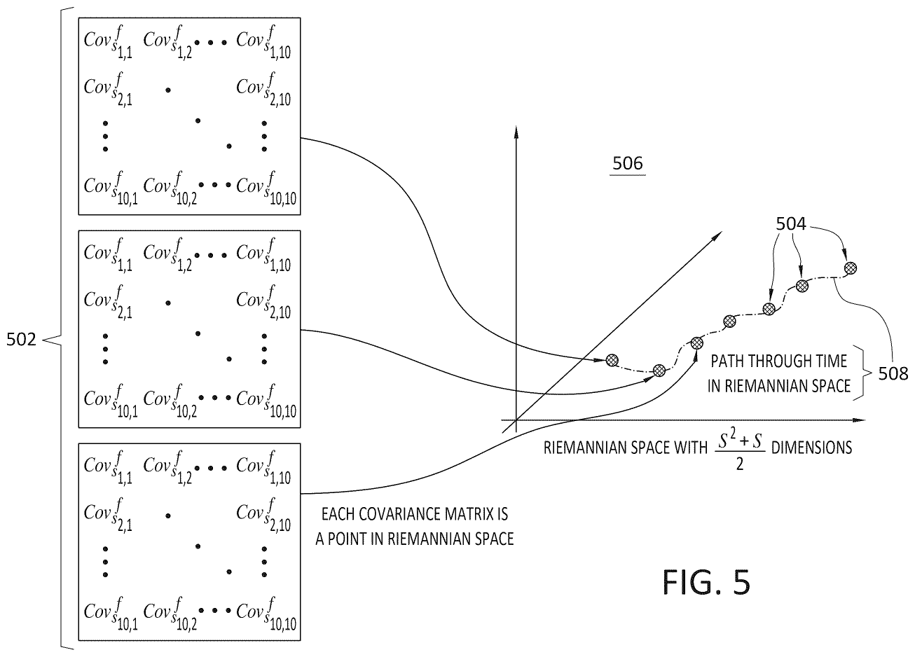

With reference now to FIG. 4, there is disclosed an example approach for calculating covariance matrices for each feature and for all systems' sensor data. More specifically, the example of FIG. 4 shows how an embodiment may calculate multiple covariance matrices 402, 404, and 406, for the same feature, one covariance matrix for each time window 408 index. These covariance matrices may then be used to create a time path in Riemannian space, as shown in FIG. 5, discussed below. In such a space, each covariance matrix becomes a single point such that appropriate geometric metrics may be used to measure distances between such points.

In more detail, the steps in FIG. 4 generate a set of covariance matrices, one per time window index. Turning now to FIG. 5, each of these covariance matrices 502 is transformed into a respective point 504 in Riemannian space 506. This Riemannian space 506 is ((S²+S)/2)-dimensional, since the S×S covariance matrix is symmetric. The set of all covariance matrix points may define a path 508 through the Riemannian space 506, for a given feature.

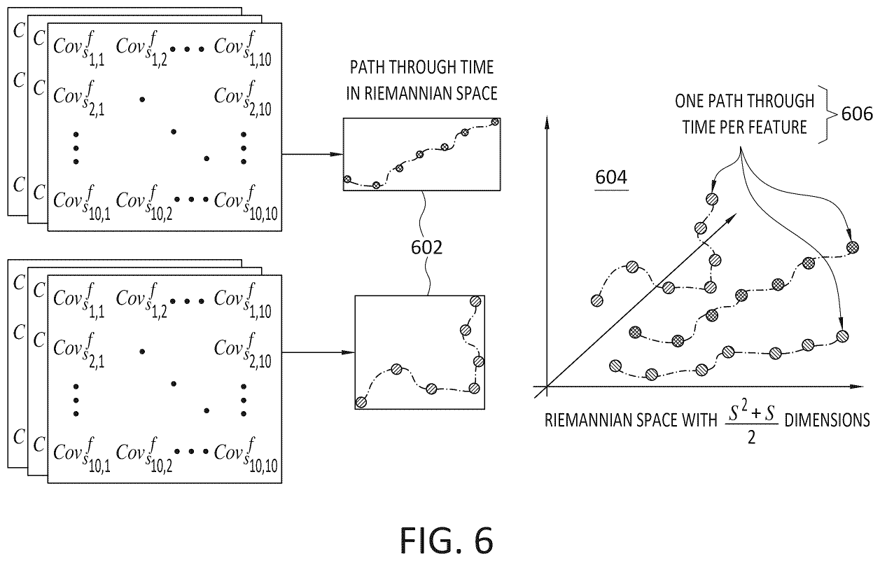

FIG. 6 discloses a first-order time-series for all features and systems in Riemannian space. In more detail, an embodiment may construct a respective path 602 through Riemannian space 604. After computing covariance for all features and all time windows indices, the result is a set of paths 606 through the is ((S²+S)/2)-dimensional Riemannian space 604.

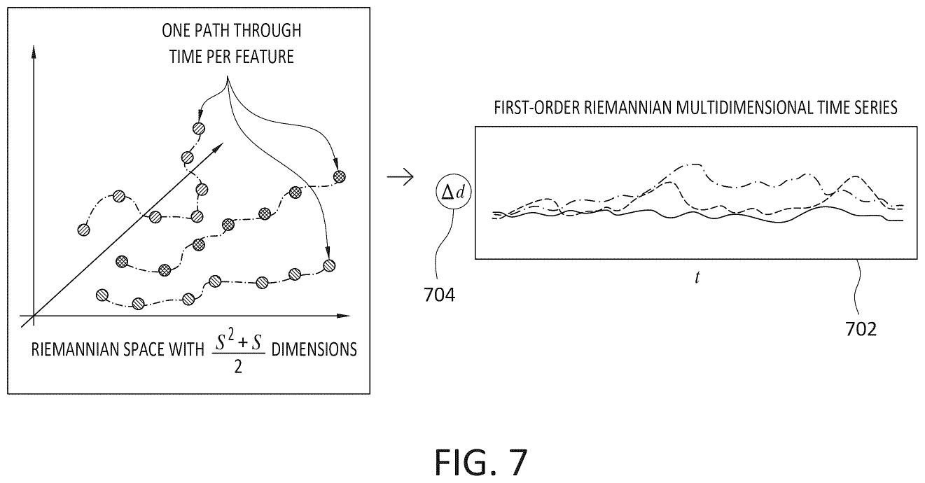

The Riemannian time paths shown in FIG. 6 together form a time-series in themselves. As noted above, this joint set of Riemannian time paths may be referred to as a first-order time-series. Since the time window index are the same for all features, an embodiment may index these Riemannian time paths into a single multi-feature first order Riemannian time series 702 as shown in FIG. 7. In this case, an embodiment may use the distance from a point in adjacent time steps as the value for the time series for that path, as shown in FIG. 7, which discloses arriving at a first-order Riemannian multidimensional time series for all features. To construct the first-order time series, one embodiment may calculate the delta Riemannian distance Δd 704 from each point to the previous point for each feature.

### D.2.3 Dimensionality Analysis on Second-Order Time Series

An embodiment may construct a second-order Riemannian time-series from the first order one constructed as discussed in connection with FIG. 7. This second-order time series is a way of aggregating the information from the many features obtained in the previous step, that is, the obtaining of the first-order time series, into an aggregate set of points on which a dimensionality analysis may be run.

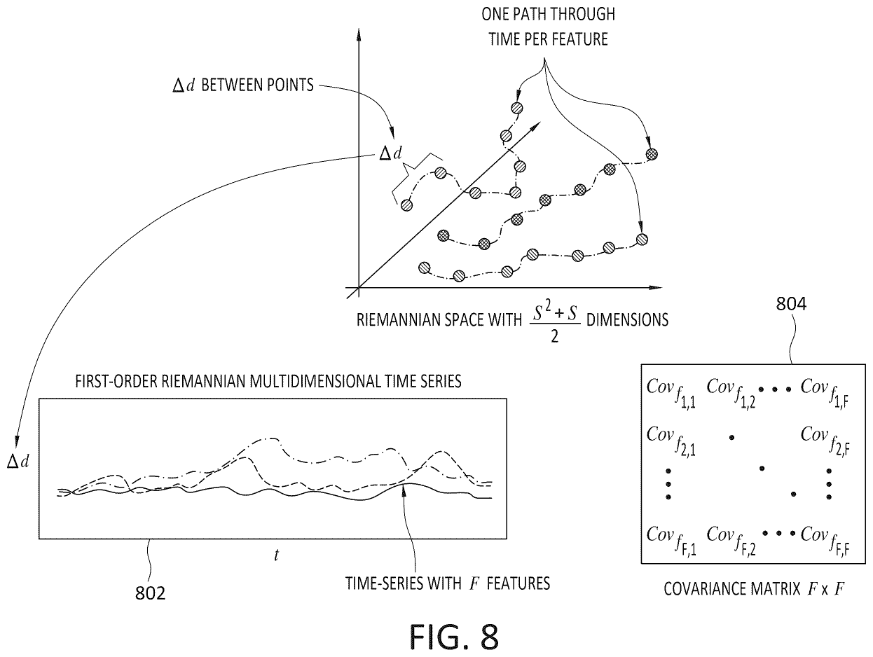

This is referred to herein as a second-order time series because it takes the covariance between the time paths obtained in the previous first-order step to construct a new time-series, as shown in FIG. 8 which discloses a covariance calculation from the first-order time series 802 construction. The scheme is analogous to what was done in the first step where the first-order time series was created, and an embodiment slides a window through the first-order time-series and calculates covariance matrices 804 that are then transformed into Riemannian points and form their own point set in a new Riemannian space. The covariance matrices 804 are F×F, with F being the total number of features. Once transformed into points in a Riemannian space, the covariance matrices map into ((F²+F)/2)-dimensional Riemannian space.

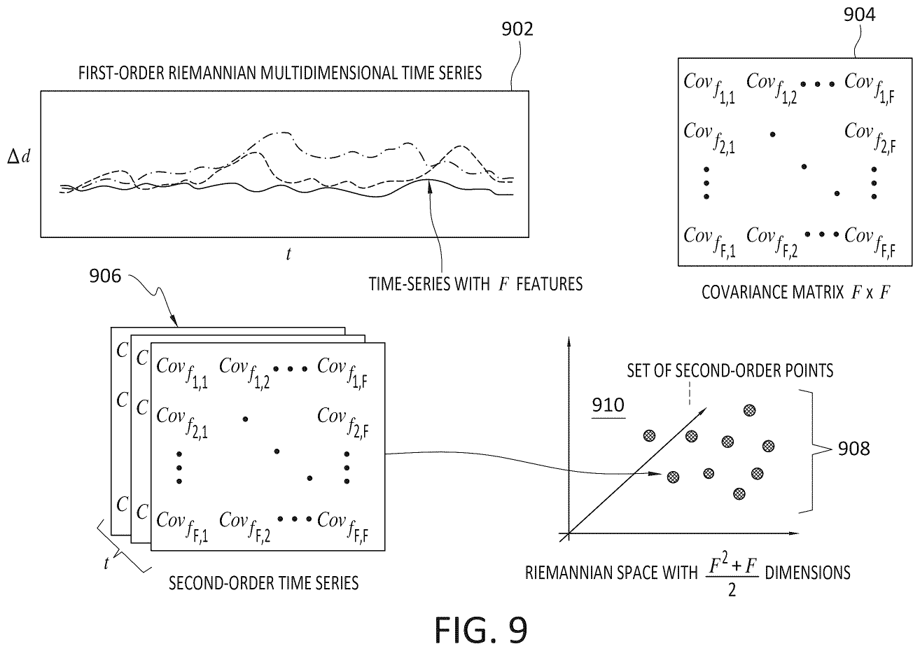

FIG. 9 discloses a second-order time series and its corresponding set of points. IN particular, and as shown in the example of FIG. 9, a first-order Riemannian multidimensional time series 902 is transformed into a covariance matrix 904 of dimensions F×F. The covariance matrix 904 is then used to generate a second-order time series 906, which is then transformed into a set of points 908 in a Riemannian space 910, that is, an ((F²+F)/2)-dimensional Riemannian space 910.

In the set of points 908 in this Riemannian space, an embodiment may apply an unsupervised dimensionality analysis technique, such as Riemannian PCA (see [2]), to extract the most relevant/important dimensions, that is, features. One embodiment may establish a threshold of information, such as variance percentile, at which dimensions are considered relevant, and then take the set of dimensions that meet the threshold as the final set of important dimensions.

After running a dimensionality analysis on the second-order point set, an embodiment may thus uncover covariances that are important. That is, each dimension is now a covariance between features. Therefore, if, for instance Cov_{f}_{₂₃} is found to be an important dimension, an embodiment will include features 2 and 3 in the set of important features. After finishing this process, the result is a set of important dimensions, or features. Finally, the set of relevant features is communicated, from the central node, back to all participant edge nodes.

### D.3 Fault-Tolerance Level Calculation

As noted above, an embodiment may compute a set of relevant dimensions at the central node and communicate those dimensions back to all edge nodes. At the current step of normative adaptation, an embodiment may use this set of features to calculate only a subset of the covariances at each edge node. This subset may then be communicated back to the central node during the normative phase.

At the central node, an embodiment may use the subset of covariance values coming from all nodes to compute a cluster of normative behavior in Riemannian space. For instance, using the Riemannian potato technique, discussed below, for clustering in non-Euclidean spaces. After such a clustering technique, an embodiment may end up with a method to calculate if, and by how much, any point—including novel points—are in relation to the cluster. The cluster then becomes the normative region.

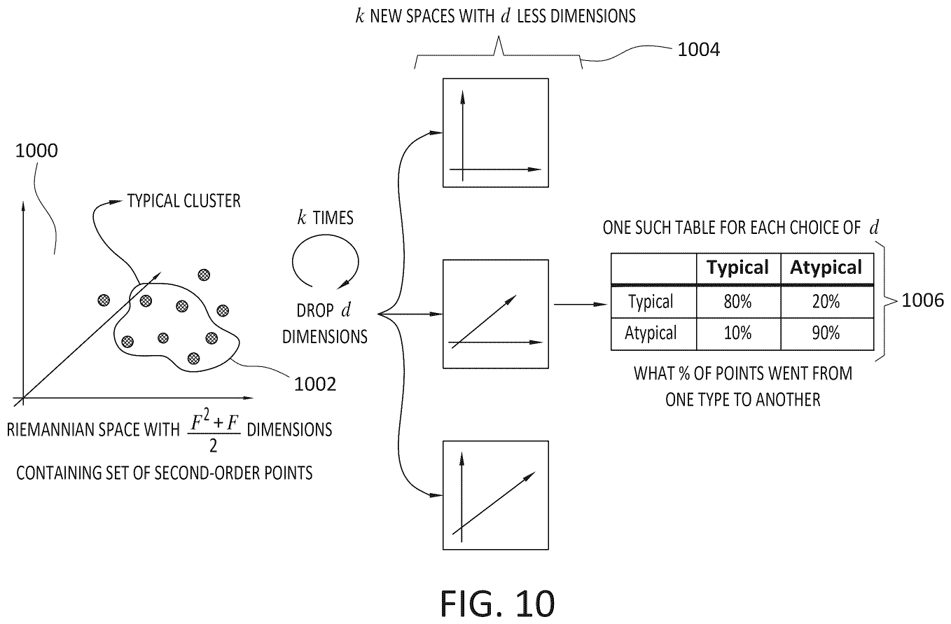

In an embodiment, and disclosed in the example of FIG. 10, the next step is to compute a fault-tolerance analysis by dropping some of the dimensions and seeing how much that affects a normative “F1-score” of the new clustering in relation to the old one. Namely, computing how many points have moved from normative to abnormal and vice versa. As shown there, given a Riemannian space 1000 that includes a cluster 1002, ‘d’ dimensions may be dropped ‘k’ times to define ‘k’ new spaces with ‘d’ fewer dimensions, 1004. A table 1006 or other structure may then be used to show, for each choice of ‘d,’ how many points of the cluster 1002 have moved from normative to abnormal and vice versa.

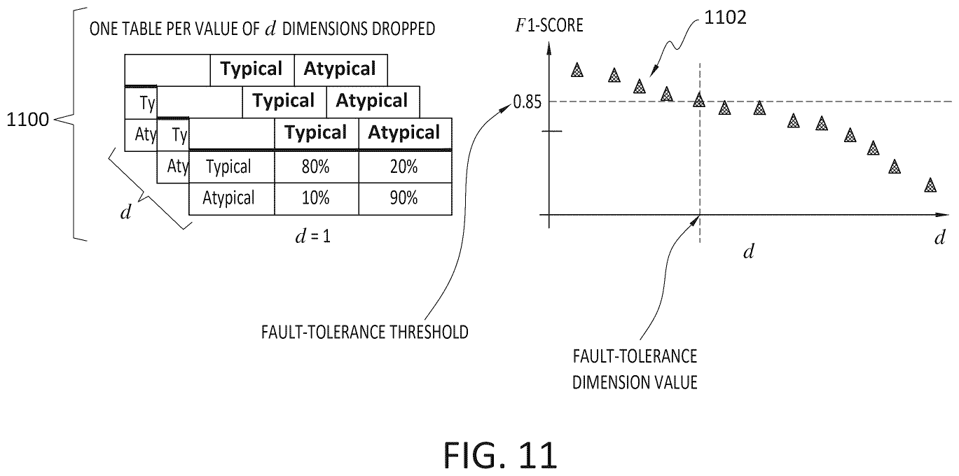

As shown in the example of FIG. 11, the information from the table 1100 may be used to construct a curve 1102 of dimensions X normative F1-score for which an embodiment may determine a threshold of acceptable fault-tolerance level per relevant dimension dropping. Some features may influence the F1-score more than others, possibly correlated with features that are more relevant. However, one embodiment may perform both analyses, that is, both feature relevance, and feature ablation. With feature relevance, an embodiment may help the system monitor its edge nodes with the knowledge of which features should be influencing more the node. And with feature ablation, an embodiment may enable the system to only raise yellow flags if behavior signals that a significant subset of features is not available. The size of this subset is given by the value for fault-tolerance found.

### D.4 Inference Phase

Once a fault-tolerance level has been computed, such as at the central node, it may be communicated back to all of the edge nodes. Each edge node may then use this fault-tolerance level to deal with its stream of data and aid in monitoring for anomalous behavior detection (see FIG. 2).

An aim of one embodiment is to monitor fault-tolerance levels and ultimately inform a system maintainer, or an automated process, when one or mode edge nodes are below a given fault-tolerance level. Below is a discussion as to how this information can be further gathered at the central node to trigger the re-calculation of the fault-tolerance level.

In one embodiment, the edge nodes may leverage existing monitoring mechanisms to assess whether certain features are available at the node. The fault-tolerance level informs the node to what extent lacking features impacts the operational capacity of the aggregate data at the central node. Hence, if sensor quality, that is, to detect drop-off, is in place, some reasoning to associate sets of sensor(s) to feature(s) may be needed. One embodiment may assume such mechanisms are in place.

As mentioned above, if a fault-tolerance quality signal is available at an edge node, it can be used to inform the central node. Once enough edge nodes, which may be established as a pre-determined number of edge nodes, inform the central node, this could trigger the protocol to return to the dimensionality analysis phase and recompute relevant features to calculate a new threshold for a fault-tolerance level. This mechanism may be implemented in different strategies, depending on characteristics of the domain. Naïve implementations, albeit computationally expensive, of this mechanism may involve simply triggering the fault-tolerance level calculation whenever a substantial subset of the nodes report feature losses that infringe threshold.

### D.5 Further Discussion

As disclosed herein, embodiment may possess various useful features and aspects, although no embodiment is required to possess any of such features or aspects. The following examples are illustrative, but not exhaustive.

An embodiment may efficiently deal with sensor features at different ranges and scales in a unifying framework for time-series analysis. As another example, an embodiment may comprise a robust framework for dealing with missing data or faulty collection by automatic calculation of a robust fault-tolerance level.

### E. APPENDIX

### E.1 Riemannian Casting of Time-Series

One way of dealing with multi-dimensional time-series is using non-Euclidean, or Riemannian space. For instance, the Riemannian Potato technique (see [1]) is a time series anomaly detection technique that has been finding applications in many domains, especially in those with noisy data, such as GPS, radar, and electroencephalography, for example. In this method, the signal is split into time windows and transformed into covariance matrices that relate the signal features/channels. These are used as sample data descriptors, of reduced dimension, compared to the original data, to define a “region of normality” on the covariance space.

Because covariance matrices lie on a Symmetric Positive Definite (SPD(n)) space, using usual straight-line distance metrics such as Euclidean distance can lead to non-admissible covariance matrices, which would have negative eigenvalues and leave the SPD(n) cone. Thus, an embodiment may adopt a curve distance metric. Since the SPD(n) space is differentiable, an embodiment can “break down” the neighborhood around each covariance matrix C into a local linearization of that space, called tangent space, where a Riemannian metric can be applied. By choosing a Riemannian metric on each tangent space, an embodiment may calculate the distance between covariance matrices following geodesics, that is, the shortest path between two points in a manifold.

The Riemannian Potato method calculates the Riemannian distance of each new sample covariance matrix to a reference matric C̅ and decides, based on a given z-score, if this sample is to be considered anomalous or not.

More formally, let x(t) be a zero-centered multivariate signal composed of N channels, each representing a different time series. Let xk be the kth time-window under consideration such that xk=[x1k . . . xNk]T where xik∈ [symbol] T i∈1 . . . N corresponds to kth time-window of the ist channel containing τ of its time step values such that xk∈ [symbol] [symbol] × [symbol] . The kth sample covariance matrix of x(t) is given by Ck=1N−1×k×kT with CK∈ [symbol] [symbol] × [symbol] .

As for illustrating the case for N=2, there would be:

$${C}_{k} = ( \begin{matrix}Var ( {x}_{1 k} ) & Cov ( {x}_{1 k} , {x}_{2 k} ) \\ Cov ( {x}_{2 k} , {x}_{1 k} ) & Var ( {x}_{2 k} )\end{matrix} ) .$$

The Riemannian metric used in the Riemannian Potato algorithm is the Fisher-Rao metric, which amounts to the following distance value:

$$δ ( \overline{C} , {C}_{k} ) = \sqrt{{{\sum }_{{n = 1}^{}}}^{N} {log}^{2} {λ}_{n}}$$

where λₙ are the eigenvalues of: C̅⁻¹Cₖ
Let C̅ be the reference covariance matrix that equals the geometric mean of a training set {C₁ . . . Cₘ} containing the first m covariance matrices of the signal x(t). A sample covariance matrix Cⱼ j>m is considered anomalous if the z-score of Cⱼ is greater than a user-defined threshold z, that is:

$$\frac{δ ( \overline{C} , {C}_{j} ) - μ}{σ} > z ,$$

where μ, σ are the mean and standard deviations of the distance to the reference matrix in the training set.

### E.2 Non-Euclidean Dimensionality Analysis

There are different techniques for dealing with dimensionality analysis in non-Euclidean geometric spaces. An example is principal component analysis (PCA) on general manifolds, particularly Riemannian manifolds (see [2]). This is a generalization of PCA on Euclidean domains. These methods are not particularly computationally more expensive, given that one has an efficient metric on the manifold. In the case of dealing with the Riemannian space of covariance matrices, we have an efficient metric, as for example the one introduced above.

As in Euclidean PCA, non-Euclidean PCA is also able to return eigenvalues and eigen vectors for each dimension. From these, we can compute a set of relevant dimensions given a threshold on the variance level that should be admitted, as in the case of Euclidean PCA. For instance, an embodiment may need to obtain a set of dimensions that hold 90% of the variance in the data and then select in order of largest eigenvalue until 90% of total variance is reached. It is noted that there are methods other than PCA for dimensionality analysis in non-Euclidean domain, but Riemannian PCA is referred to here for its straightforwardness and computational efficiency.

### F. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. FURTHER EXAMPLE EMBODIMENTS

Following are some further example embodiments. These are presented only by way of example and are not intended to limit the scope of this disclosure or the claims in any way.

Embodiment 1. A method for determining a fault tolerance level for sensor dimensions, comprising: receiving data from each edge node in a group of edge nodes; for each sensor feature across all edge nodes, using the data to calculate covariance matrices at each time window, and each sensor feature becoming a path in geometric Riemannian space, forming a first-order multidimensional Riemannian time-series, where each dimension corresponds to a correlation dimension between two edge nodes; creating, from a first-order multidimensional Riemannian time-series, a second-order covariance geometric Riemannian space; using a non-Euclidean PCA at a second-order covariance geometric Riemannian space to determine most relevant dimensions in the group of dimensions; communicating respective indices of the most relevant dimensions to the edge nodes; receiving, from each of the edge nodes, covariances between the most relevant dimensions; generating a normative cluster of behavior from all of the edge nodes; performing a fault-tolerance analysis based on the normative cluster; and based on the fault-tolerance analysis, generating a curve usable to determine a threshold of acceptable fault-tolerance level.

Embodiment 2. The method as recited in any preceding embodiment, wherein each of the edge nodes comprises a respective sensor of an edge environment.

Embodiment 3. The method as recited in any preceding embodiment, wherein one of the sensor dimensions behaves in a respective range, and scale, that are different from a range and scale of another of the sensor dimensions.

Embodiment 4. The method as recited in any preceding embodiment, wherein performing the fault-tolerance analysis comprises dropping one or more dimensions from the cluster to determine an effect on a score of a new cluster defined by the dropping of the one or more dimensions.

Embodiment 5. The method as recited in embodiment 4, wherein the score indicates an extent to which points in the cluster move from ‘normative’ to ‘abnormal,’ and/or from ‘abnormal’ to ‘normative.’

Embodiment 6. The method as recited in any preceding embodiment, wherein the covariance matrices are calculated for multiple different time window indices for each dimension.

Embodiment 7. The method as recited in any preceding embodiment, wherein a fault tolerance threshold from the curve is transmitted to the edge nodes.

Embodiment 8. The method as recited in embodiment 7, wherein the fault tolerance threshold is usable by the edge nodes to detect anomalous behavior in data received by the edge nodes.

Embodiment 9. The method as recited in embodiment 7, wherein the fault tolerance threshold is automatically recalculated when a specified number of the edge nodes determine that data received by those edge nodes is out of tolerance.

Embodiment 10. The method as recited in embodiment 7, wherein the data received from the edge nodes does not include data that fails to meet the fault tolerance threshold.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

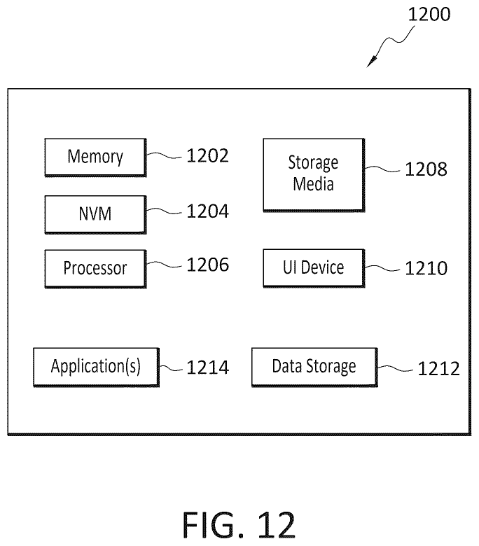

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for determining a fault tolerance level for sensor features, comprising:
receiving data from each edge node in a group of edge nodes;
for each sensor feature across all edge nodes, using the data to calculate covariance matrices at each time window, and each sensor feature becoming a path in geometric Riemannian space, forming a first-order multidimensional Riemannian time-series, where each dimension corresponds to a correlation dimension between two edge nodes;
creating, from a first-order multidimensional Riemannian time-series, a second-order covariance geometric Riemannian space;
using a non-Euclidean PCA at a second-order covariance geometric Riemannian space to determine most relevant dimensions in the group of dimensions;
communicating respective indices of the most relevant dimensions to the edge nodes;
receiving, from each of the edge nodes, covariances between the most relevant dimensions;
generating a normative cluster of behavior from all of the edge nodes;
performing a fault-tolerance analysis based on the normative cluster; and
based on the fault-tolerance analysis, generating a curve usable to determine a threshold of acceptable fault-tolerance level.

2. The method as recited in claim 1, wherein each of the edge nodes comprises a respective sensor of an edge environment.

3. The method as recited in claim 1, wherein one of the sensor dimensions behaves in a respective range, and scale, that are different from a range and scale of another of the sensor dimensions.

4. The method as recited in claim 1, wherein performing the fault-tolerance analysis comprises dropping one or more dimensions from the cluster to determine an effect on a score of a new cluster defined by the dropping of the one or more dimensions.

5. The method as recited in claim 4, wherein the score indicates an extent to which points in the cluster move from ‘normative’ to ‘abnormal,’ and/or from ‘abnormal’ to ‘normative’.

6. The method as recited in claim 1, wherein the covariance matrices are calculated for multiple different time window indices for each dimension.

7. The method as recited in claim 1, wherein a fault tolerance threshold from the curve is transmitted to the edge nodes.

8. The method as recited in claim 7, wherein the fault tolerance threshold is usable by the edge nodes to detect anomalous behavior in data received by the edge nodes.

9. The method as recited in claim 7, wherein the fault tolerance threshold is automatically recalculated when a specified number of the edge nodes determine that data received by those edge nodes is out of tolerance.

10. The method as recited in claim 7, wherein the data received from the edge nodes does not include data that fails to meet the fault tolerance threshold.

11. A non-transitory storage medium having stored therein instructions that are executable by one or more hardware processors to perform operations comprising:
receiving data from each edge node in a group of edge nodes;
for each sensor feature across all edge nodes, using the data to calculate covariance matrices at each time window, and each sensor feature becoming a path in geometric Riemannian space, forming a first-order multidimensional Riemannian time-series, where each dimension corresponds to a correlation dimension between two edge nodes;
creating, from a first-order multidimensional Riemannian time-series, a second-order covariance geometric Riemannian space;
using a non-Euclidean PCA at a second-order covariance geometric Riemannian space to determine most relevant dimensions in the group of dimensions;
communicating respective indices of the most relevant dimensions to the edge nodes;
receiving, from each of the edge nodes, covariances between the most relevant dimensions;
generating a normative cluster of behavior from all of the edge nodes;
performing a fault-tolerance analysis based on the normative cluster; and
based on the fault-tolerance analysis, generating a curve usable to determine a threshold of acceptable fault-tolerance level.

12. The non-transitory storage medium as recited in claim 11, wherein each of the edge nodes comprises a respective sensor of an edge environment.

13. The non-transitory storage medium as recited in claim 11, wherein one of the sensor dimensions behaves in a respective range, and scale, that are different from a range and scale of another of the sensor dimensions.

14. The non-transitory storage medium as recited in claim 11, wherein performing the fault-tolerance analysis comprises dropping one or more dimensions from the cluster to determine an effect on a score of a new cluster defined by the dropping of the one or more dimensions.

15. The non-transitory storage medium as recited in claim 14, wherein the score indicates an extent to which points in the cluster move from ‘normative’ to ‘abnormal,’ and/or from ‘abnormal’ to ‘normative’.

16. The non-transitory storage medium as recited in claim 11, wherein the covariance matrices are calculated for multiple different time window indices for each dimension.

17. The non-transitory storage medium as recited in claim 11, wherein a fault tolerance threshold from the curve is transmitted to the edge nodes.

18. The non-transitory storage medium as recited in claim 17, wherein the fault tolerance threshold is usable by the edge nodes to detect anomalous behavior in data received by the edge nodes.

19. The non-transitory storage medium as recited in claim 17, wherein the fault tolerance threshold is automatically recalculated when a specified number of the edge nodes determine that data received by those edge nodes is out of tolerance.

20. The non-transitory storage medium as recited in claim 17, wherein the data received from the edge nodes does not include data that fails to meet the fault tolerance threshold.
